(19) United States
(12) Patent Application Publication
(10) Pub. No.: US 2015/0305396 A1
(43) Pub. Date: Oct. 29, 2015

(54) FOOD PACKAGING METHOD AND APPARATUS

(71) Applicants: Mark A. COTTONE, West Chicago, IL (US); COUGAR PACKAGING CONCEPTS, West Chicago, IL (US)

(72) Inventor: Mark A. Cottone, West Chicago, IL (US)

(73) Assignee: COUGAR PACKAGING CONCEPTS, West Chicago, IL (US)

(21) Appl. No.: 14/649,594

(22) PCT Filed: Dec. 6, 2013
(86) PCT No.: PCT/US2013/073615

§ 371 Date: Jun. 4, 2015

Related U.S. Application Data
(60) Provisional application No. 61/734,477, filed on Dec. 7, 2012.

(51) Int. Cl. A23L 3/28; B65B 5/04; A23L 3/3445; B65B 35/24; B65B 55/16; B65B 55/18; B65B 25/00; B65B 31/02

(52) U.S. Cl. CPC A23L 3/28; B65B 25/001; B65B 5/04; B65B 31/028; B65B 35/24; B65B 55/16; B65B 55/18; A23L 3/3445; A23V 2002/00

(57) ABSTRACT

A method and apparatus for treating and packaging foodstuffs having a supply for product to be treated and packaged, a conveyor for product, a sanitizing station through which product is progressed, where the sanitizing station uses a pulsed UV light source operated to an extent to provide a sanitizing effect on the product as product passes through the sanitizing station. The product is then conveyed from the sanitizing station and supplied to containers which are then processed in a MAP system station, wherein the product is sealed in the containers which are provided with a modified atmosphere within the containers. Alternatively, or in addition, the product can be subjected to an ozone gas treatment prior to MAP containment.

### CROSS REFERENCE TO RELATED APPLICATIONS

The present application claims priority from U.S. application 61/734,477, filed Dec. 7, 2012, the entirety of which is incorporated herein by reference.

### BACKGROUND OF THE INVENTION

The present invention generally relates to food processing and packaging, and more particularly relates to a system incorporating a sanitization of the foodstuff before packaging, and more preferably further followed by a treatment which extends the shelf life of the foodstuff in the packaging thereof.

### SUMMARY OF THE INVENTION

In the handling of many foodstuffs, it is a recognized method of food safety to subject the product to ultraviolet (UV) light. This may be considered a sanitization procedure in many respects. The UV light when applied properly is capable of reducing if not eliminating certain pathogens and other deleterious materials and substances that may be on the outside of the product. In some instances, the UV light may further pass through the surface of the produce and into the product, depending on the nature of the product, and whether such interior treatment is desired.

Pulsed UV light is also a known way to treat foodstuffs in the foregoing manner. The UV light is pulsed in part to increase the effective amount of energy applied to the product at one time yet reducing the dwell time of the UV light so as not to harm the product through overexposure.

It is also known to package a foodstuff in a manner where the surrounding environment of the product has been modified from ambient air. For instance, modified atmosphere packaging (MAP) is used to contain a product in an environment of reduced or substantially eliminated oxygen, as by replacing air with nitrogen gas, carbon dioxide gas, and so forth; vacuum treatment is also a way to modify the ordinary package environment. These kinds of operations create an atmosphere for the packaged product which slows the effects of common spoilage processes ordinarily at work on the product.

The present invention in one aspect combines a pulsed UV light treatment of a product, or foodstuff, with a subsequent step of a MAP operation. In a further aspect of the invention, the product is first treated with a pulsed UV light, and in the packaging step the product in its container is initially subjected to an ozone flush. The ozone treatment further increases the sanitization of certain foodstuffs, and therefore can be of significant benefit. The ozone is then promptly removed in the MAP operation, which provides the environment for the finished packaged product.

In yet another aspect of the invention, there is no initial pulsed UV light treatment, but instead the foregoing ozone treatment is applied followed by a MAP operation.

These and other aspects, advantages, applications and features of the invention will be further understood upon consideration of the following detailed description, taking in conjunction with the drawing, in which:

### BRIEF DESCRIPTION OF THE DRAWING

FIG. 1 is a schematic rendering showing an embodiment of the invention in which a foodstuff is conveyed through steps involving treatment by pulsed UV light, and then packaging in a MAP process, and further including the option of an ozone gas flush prior to the MAP process.

### DETAILED DESCRIPTION OF AN EMBODIMENT

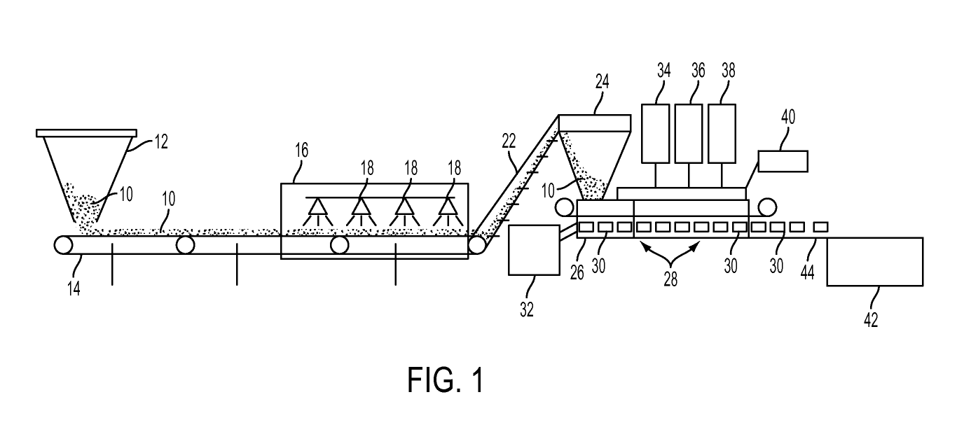

FIG. 1 shows in diagrammatic form an embodiment of the invention for processing a foodstuff, such as blueberries 10. Of course, the invention is not limited to such a product alone, but is applicable to many different kinds of foodstuffs and products, whether fruit, vegetable, meat, fish, confection and so on. Conceptually, it is useful for any kind of product which is subject to degradation, e.g., spoilage, over time, so as to extend the useful life of the product, as by increasing its shelf life. The invention can also apply to treatments that may simply improve the appearance and safety of the packaged product.

In this embodiment, blueberries 10 are loaded into a hopper 12 for supply to a first conveyor system 14. The manner in which the product is supplied may be of many known types, and the conveyor system 14 is conventional. Workers may initially observe or otherwise scan the product on the conveyor 14 for products that do not meet a visual inspection test.

The berries 10 then progress to a UV light station or tunnel 16. Pulsed UV lights 18 are arranged in the tunnel in suitable number and at appropriate distances to sanitize the product to the desired amount. In this embodiment, UV light sources with about 505 joules of energy per cm3 are shown. The desired exposure rate may be up to about three pulses per second to deliver somewhere between about 3 to about 50 joules per cm3 to the product passing through the tunnel. The exposure pulse will be adjusted based upon the kind of product, the desired level of treatment and production rate, to name three significant factors to take into consideration. With the foregoing type of light source and blueberries as the product, a distance between light source and conveyor bed of about one inch to about 5 inches is expected to be most useful. The speed of the conveyor belt and operation of the pulsed light sources will be appropriately controlled as by a computer processor operated system.

It will be noted that reflectors or reflective surfaces may be employed in the tunnel 16 to maximize the use of the pulsed UV light. Appropriate shielding may be used to protect workers from the UV light. The tunnel 16 may additionally have a ventilation component for removing ozone gas that may be a byproduct of the light treatment. The portion of the conveyor 14 in the tunnel 16 may additionally be provided with an apparatus to agitate the product, so as to expose all sides of the product to the UV light. This might include a mechanism to physically rotate the product in the course of passage. In certain applications, the UV light sources may be positioned in manner to surround the product. This could employ a conveyor portion that is transparent to UV light, to enable treatment from below the product.

Having been effectively treated with the pulsed UV light, the product (blueberries) then progress up an elevator 22 to a packaging supply hopper 24. It will be noted that the UV tunnel 16, elevator 22 and supply hopper 24 are preferably in an enclosed environment, so as to minimize any exposure of the UV treated product to ambient air. It will further be understood that the use of an elevator and supply hopper are but one way to transport treated product for packaging. Other arrangements for getting the UV product from the tunnel 16 to a packaging station are well known and understood to those of skill.

Berries from the supply hopper 24 are then supplied in metered fashion to a container filling station 26. The filling station 26 may be prior to a MAP system 28, or part of the MAP system itself, or something else. In this schematic approach, containers 30 are provided from a container supply 32 to the filling station 26/MAP system 28, where they are filled with product in a known manner. Containers of plastic, pulp, foil or other types may be used.

The filled containers 30 are then further processed using MAP equipment such as that provided by Hefestus Ltd., and shown for example in U.S. Pat. No. 6,912,828, the disclosure of which is incorporated herein by reference. This is but one type of MAP equipment, and others may be used to advantage as well.

In this particular embodiment, the interior of the container 30 is first subjected to an ozone gas treatment, or ozone flush. This ozone application may be best supplied using a laminar flow technique, or a venturi flow. Reference can be made to the aforementioned process and apparatus of U.S. Pat. No. 6,912,828. The ozone application would be of short duration, such as on the order of about 0.1 to about 1 second, so as not to deleteriously affect a foodstuff such as berries. Ozone is schematically shown being supplied from ozone source 34.

The ozone is promptly eliminated by further operation of the MAP system. It will be understood that no ozone treatment may be used at all, however.

Container atmosphere modifications may include the introduction of an increased nitrogen atmosphere, shown here being supplied by nitrogen gas source 36. For example, the amount of nitrogen to remain in the container may be in the range of about 60% to close to 100%, depending on desires. An increased atmosphere of carbon dioxide may be desired, with carbon dioxide shown here supplied from source 38. Other gases may be employed commonly used in food packaging. A mix of gases (which may be premized) may be applied. In a similar vein, a vacuum or negative pressure may be introduced to the container interior. A vacuum supply is shown at source 40. In each instance, the oxygen content of the package will typically be reduced, however, perhaps somewhere in the range of 15% to almost zero, such as in the instance of packaging blueberries. There are instances where the oxygen content of the package may be desired to be increased. This has been found to be useful in the packaging of fish, for instance. Again, the atmosphere of the container package is intended to be adjustable as the contents of the package may dictate.

With the desired atmosphere now present in the container 30, it is then sealed. This might be with a covering of a barrier film of many types and compositions, including breathable as well as “smart” films, which permit outgassing of certain effluents of the product over time, while still retaining some or all of the modified atmosphere gas(es). Sealing is done with the conventional equipment of the MAP system 28.

The processed and sealed containers 30 then progress from the MAP system 28, as by a post-MAP conveyor section 44, to a collection and boxing station 42, for warehousing then shipping. Again, how the sealed containers are handled is a matter of choice.

The present invention is thus considered to yield an improved method and apparatus for processing and packaging products, such as foodstuffs, by significantly increasing the longevity, e.g., shelf life, of the product. While the invention has been described with respect to a particular embodiment(s), and application in a specific environment, those of skill will recognize modifications of components, elements, materials, arrangements and the like which will still fall within the spirit and scope of the invention, and the invention is not to be limited to such embodiment(s) or specific details.

What is claimed is:

1. A method for treating and packaging foodstuffs, comprising:
providing a product for treatment and packaging;
subjecting said product to a pulsed UV light source to an extent to provide a sanitizing effect on the product; and
enclosing said UV light treated product in a container using a MAP technique.

2. The method of claim 1, further including the step of subjecting said product to an ozone gas treatment prior to said MAP technique.

3. A method for treating and packaging foodstuffs, comprising:
providing a product for treatment and packaging;
subjecting said product to an ozone gas treatment; and
enclosing said ozone treated product in a container using a MAP technique.

4. The method of claim 3 wherein said product is subjected to a pulsed UV light source to an extent to provide a sanitizing effect on the product prior to said ozone treatment.

5. The method of claim 1, wherein said MAP technique includes enclosing said product in a container having a modified atmosphere within the container of one or more of nitrogen or carbon dioxide in a concentration greater than ambient air.

6. The method of claim 1 wherein said pulsed UV light source provides an exposure to the product of between about 3 to about 50 joules per centimeter cubed.

7. An apparatus for treating and packaging foodstuffs, comprising:
a supply for product to be treated and packaged;
a conveyor for product;
a sanitizing station through which product is progressed, said sanitizing station having a pulsed UV light source operated to an extent to provide a sanitizing effect on the product as product passes through said sanitizing station;
said product being conveyed from said sanitizing station and supplied to containers which are then processed in a MAP system station, wherein said product is sealed in said containers which are provided with a modified atmosphere within said containers.

8. The apparatus of claim 7 further including a supply of ozone gas, said ozone gas being applied to said product prior to said MAP system application of a modified atmosphere.

9. An apparatus for treating and packaging foodstuffs, comprising:
a supply for product to be treated and packaged;
a conveyor for product;
an ozone treatment station in which product is progressed, and treated with an ozone flush from a supply of ozone gas;
said product then being processed in a MAP system station, wherein said product is sealed in containers which are provided with a modified atmosphere within said containers and said ozone gas is substantially eliminated.

10. The apparatus of claim 9, further including a pulsed UV light source operated to an extent to provide a sanitizing effect on the product as product passes through said sanitizing station, and then to said ozone treatment station.

11. The method of claim 1 wherein said MAP technique includes subjecting said container interior to a negative pressure environment.

12. The apparatus of claim 7 including a source of vacuum, and wherein said MAP system station subjects said container to a negative pressure environment.
